(19) United States
(12) Patent Application Publication
(10) Pub. No.: US 2007/0149257 A1
(43) Pub. Date: Jun. 28, 2007

(54) Novel design for a wireless network device

(76) Inventors: Matthew Cheresh, Santa Barbara, CA (US); Steven Riley, Summerland, CA (US)

Correspondence Address: MARK RODGERS, 1590 SAN ROQUE ROAD, SANTA BARBARA, CA, 93105, US

(21) Appl. No.: 11/319,860

(22) Filed: Dec. 27, 2005

(51) Int. Cl. H04B 1/38

(52) U.S. Cl. 455/574; 455/572

(57) ABSTRACT

The invention is a device, and a method of operating the device, for use in a wireless network, where the device may have to run on battery power, or other limited energy sources. The device saves battery power by employing two wireless radios. The primary radio is a fully featured unit that supports full network communications protocols. The secondary radio is a simple device, possibly of shorter or longer range, which is capable of rudimentary receipt, and possibly transmission, of simple communication. Such a secondary radio can be chosen to have significantly less power consumption than a fully featured radio. Thus the device can be operated, in a variety of novel schemes, with the secondary radio on and the primary radio off. The primary radio need only be turned on when full communication is required. Typically radio communication is the primary power draw in portable wireless devices, so the novel device can operate on less power than existing devices.

### RELATED APPLICATIONS

Not Applicable

### FEDERALLY SPONSORED RESEARCH

Not Applicable

### SEQUENCE LISTING

Not Applicable

### BACKGROUND OF THE INVENTION

The invention relates to wireless networks, and in particular battery powered devices on such networks. The invention is a novel device, and schemes to operate the device. The use of the novel device and associated methods of operation result in significantly less battery power consumption than existing devices.

Wireless networks have long been used in applications such as personal or corporate PC networks. In these type of networks, even if the network nodes are battery powered, access to power to charge batteries is typically easily available, and there is no expectation that such devices need to last more than a few hours on battery charge. Although cellular communications is a type of wireless network where all devices usually operate on battery power most of the time, again the expected use means battery charging every few days at the longest is totally acceptable.

However, emerging applications for wireless networks are not so forgiving in terms of power consumption requirements. One important new application is the use of autonomous or semi-autonomous networked devices used for data collection or control in implementations such as environmental monitoring, security/surveillance, vehicle fleet tracking, and the like. In such applications, a typical network device may be a rugged, battery-powered unit containing a processor, input/output devices and a radio. Often these devices are connected through a mesh network or other network of suitable functionality. These devices may be spread over large geographic areas, and placed in locations which are not always accessible. Such devices need to last a long time, possibly as long as months, on a battery charge.

Modern microelectronics can be designed for very low power consumption, particularly for many mesh network applications. However radio communications has power consumption requirements that at some level are set by parameters such as range and bandwidth. No matter how efficient the electronic design of the radio, these parameters set the lower limit for power consumption.

In practice, the radio is usually the largest power draw component in a wireless device by a large margin. Anyone with a wireless enabled PDA will have observed that the battery may stay charged for days performing data entry and organization functions, but connect wirelessly to the internet, and the battery needs charging in at most a few hours.

The type of communication required to support a mesh network is bandwidth intensive, as each individual node is intelligent and the network, in a way, functions as a parallel processor, with each node being a parallel element. Moreover, when many of the nodes are required to be in communication at once to support a group processing or communications function, often the range of wireless communication must be large to reach all of the nodes. So for many applications, the type of radio used is dictated by the network requirements, such as number of channels, data rates, communications protocol and range. As the radio typically consumes a large percentage of power, these restrictions have provided designers few options to control power consumption in many mesh network applications.

### BRIEF SUMMARY OF THE INVENTION

Therefore, the invention is a novel design for a device on a wireless network. The novel device typically contains (see FIG. 1) a processor 1 and a battery 2 or other limited energy power source (solar, mechanical generated energy), and may contain input/output devices 3. The device contains a primary wireless radio 4, configured to support network standard or proprietary communications protocols, and a secondary radio 5, configured to support a limited communications protocol and operable in at least one mode on less power than the primary radio. In a preferred embodiment, the secondary radio operates on less power than the primary radio in receive mode. An exemplary standard protocol is 802.15.4. For a specific implementation, the primary radio, when in receive mode, consumes around 20 ma (60 mw @ 3V). The secondary radio will consume around 9 ua (0.027 mw @ 3V) when waiting (low power receive detection) for an incoming signal. In various versions, the two radios can share one antenna or the two radios can have separate and independent antennas.

Embodiments of the invention also includes methods of operating the novel device to achieve reduced power consumption. The methods may include various steps, all or part of which may be used in combination or separately.

For instance, the device may, for at least a time period, operate with the primary radio turned off, and for at least part of the time period that the primary radio is off, operate with the secondary radio on. Either radio may be turned on or off at predetermined duty cycles or their activation/deactivation may be event driven. When the secondary radio is on, it may either wait for a communication from a network, or periodically query the network. In either case upon receipt of a communication by the secondary radio, the device determines a first case that the communication is a request for full communication with a network and/or a second case that the communication is intended for re-broadcast. In the first case, the device causes the primary radio to turn on and connect to the network and in the second case, causes one of the radios to re-broadcasting the communication. A further step may be included of, upon completion of any tasks requiring the participation of the primary radio, returning to a mode where the primary is inactive and the secondary is used to detect network activity. In another embodiment, the invention supports simultaneous communications (when two antennas are used) or ping-pong ping-pong/alternating communications when the same antenna is used.

### BRIEF DESCRIPTION OF THE DRAWINGS

The invention will be better understood by referring to the following figures.

FIG. 1 shows the novel device in block diagram form.

FIG. 2 is an embodiment of a method of operating the novel device.

FIG. 3 is another embodiment of a method of operating the novel device.

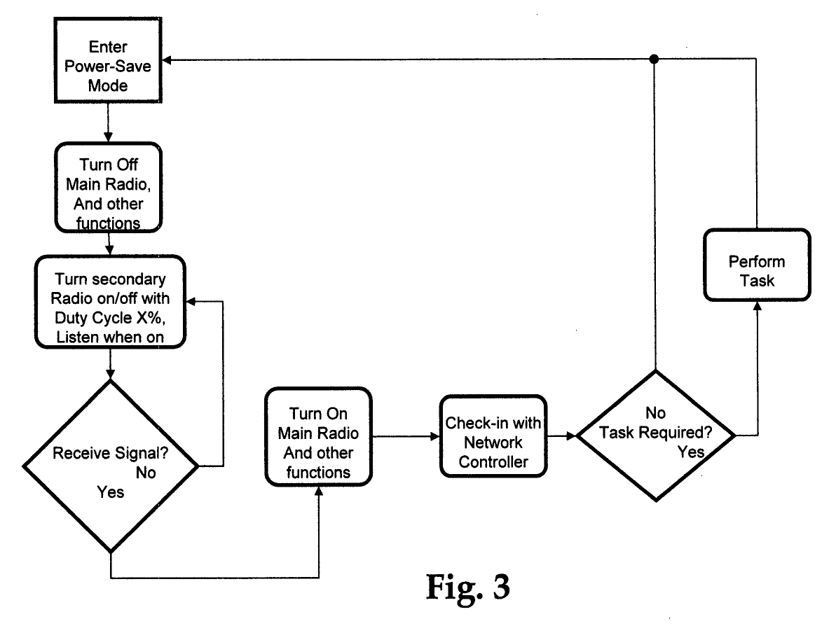

FIG. 4 is a further embodiment of a method of operating the novel device.

### DETAILED DESCRIPTION OF THE INVENTION

The invention relies on the fact that for many mesh or multi-device network applications, radio communication that meets standard or proprietary protocol requirements is not required 100% of the time. For instance, a surveillance or security device often need only communicate with the network during an event, and may be perfectly fine for most of the time with no radio communication at all. Similarly, the devices on a monitoring or tracking network often need only communicate when queried. The other characteristic of many networks is that fully featured communication, ie multi-channel, high bandwidth, high redundancy is required only when the network is in mesh or other multi-device topologies mode.

However the nature of many mesh applications is such that the devices can be in a quiescent state for long periods of time. Therefore the first communication between a device on the network, in many cases, is simply a notice from the network to the device to wake up and check in, or a simple query from the device to the network to find out if waking up is necessary. This can be exploited by treating the two types of communications, fully featured as opposed to check-in, as different hardware requirements in the network device design.

Many approaches exist for having network devices operate in a “sleep” mode to conserve power when they are not needed to be active. And some practitioners have proposed using secondary power systems which run at lower voltage or clock speed to further reduce power when in sleep modes. Also some practitioners have proposed multiple radios in network devices, but these have all been to support multiple, fully-featured communications protocols in one device

What the inventors have discovered is that the largest power user in the device is the radio, and that a secondary radio can be employed which uses much less power than a mesh network enabled radio, particularly during modes of operation where the device is in waiting to receive communication. The key to the invention is exploiting the fact that when the device is not actively on the network, a far simpler, lower-power radio can be used to either wake up the device or perform simple network queries. Thus the high power primary radio can be off, while the lower power secondary retains sufficient communication with the network to maintain contact.

The invention encompasses a variety of configurations. For instance, the two radios can share one antenna or the two radios can have separate & independent antennas. For a particular implementation built by the inventors, the primary radio, when in receive mode, consumes around 20 ma (60 mw @ 3V). The secondary radio will consume around 9 ua (0.027 mw @ 3V) when waiting (low power receive detection) for an incoming signal. This specific implementation allows for the secondary radio to remain in receive mode with very low power consumption. Although this particular secondary radio draws comparable power to the primary when in transmit mode, the inventors also contemplate the use of other types of secondary radios, which may use less power than a primary in both receive and transmit modes, possibly with trade-offs in range or other parameters, to support the various operational modes which will be described below.

Once the novel device is supported on a network, a variety of operating modes may be employed to trade-off the communications requirements (range, acceptable quiescent mode behavior, and so on) with power consumption for a particular application.

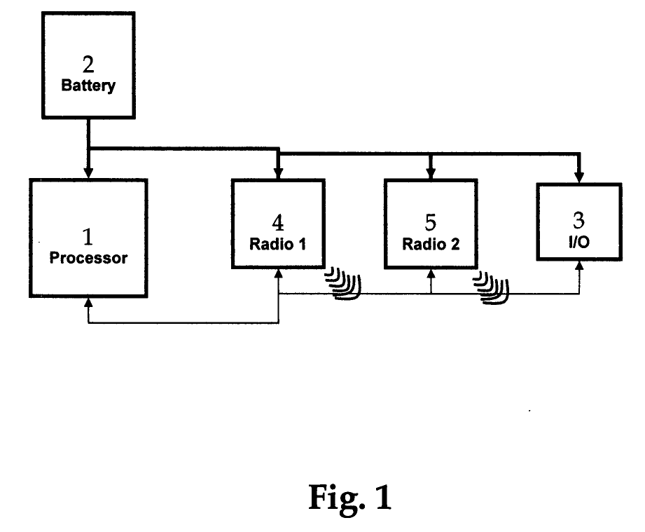

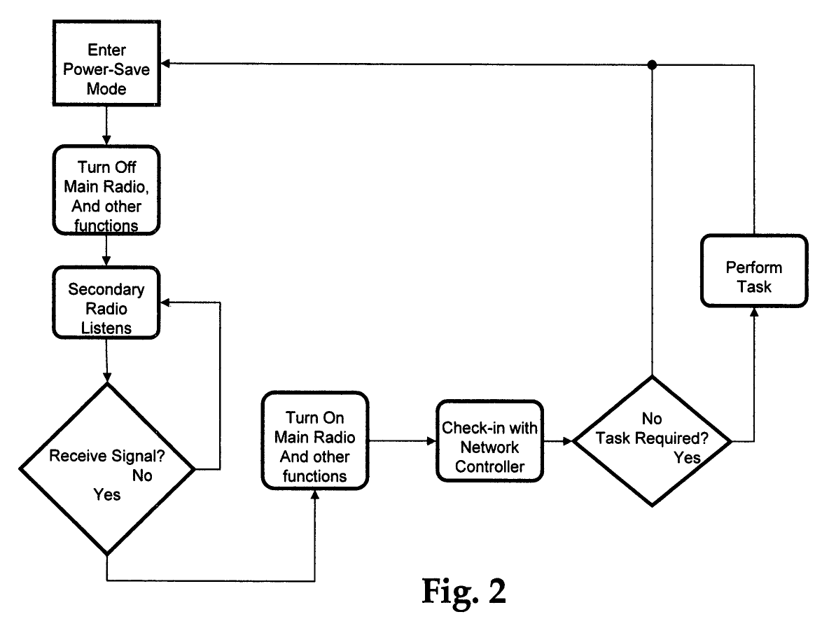

One generally useful way, FIG. 1, to operate the device is to enter a power save mode where the primary radio is turned off. The secondary radio can be on during this period, or to save even more power, can be cycled on and off, either at some predetermined duty cycle, or at regular intervals as shown in FIG. 2. The less time critical the need for a device to respond for a particular application, the more time the secondary radio can remain off. For instance, for many applications, it may be quite acceptable for devices on the network to be in sleep mode, and any signal sent to wake a particular device or devices can be repeated until a secondary radio in a device comes on.

When the secondary radio comes on, it can either passively listen for a communication from the network, or can actively query the network to see if any communication is required. The secondary radio can be configured simply to recognize if a communication is for it's device, and to inform the device processor accordingly. In this simplest mode of operation, the secondary radio recognizes communications intended for it's device, which causes the primary radio to be turned on. From this point the primary radio connects to the network, which allows the device to determine any required action. Typically, when done responding to the communication, the primary radio will be turned off, and the secondary radio will resume the task of determining when wake-up is next required.

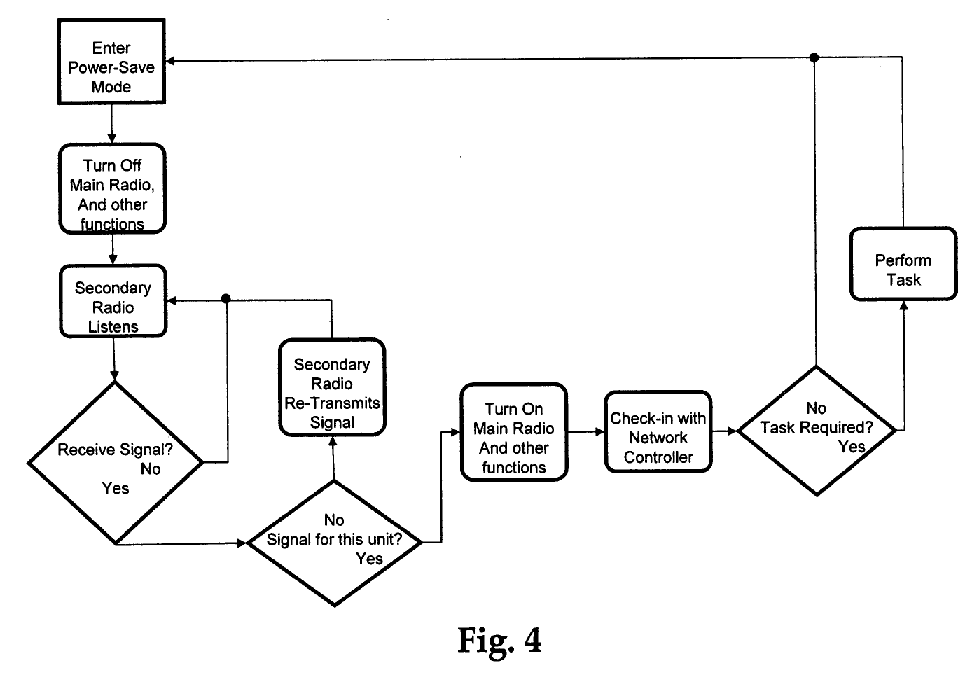

For the scenario described above, the secondary radio need only receive transmissions, and this is a useful embodiment of the invention. However radios of the type described above, which are suitable as secondary radios, may also be configured to transmit as well. This embodiment is useful for the case where devices on the network may be separated by distances too great for all devices to be in range of all other devices. In this case, the secondary radio can determine if a communication is meant for it's device or needs to be relayed as shown in FIG. 4. If the message needs to re-broadcast, depending on the particular application, the primary radio may or may not be activated. Another possible occurrence is that the communication requires both waking of the primary radio and re-broadcasting the signal to relay to other devices on the network.

Power can be saved in other operating regimes than sleep/wake cycles. For instance, the invention supports simultaneous communications (when two antennas are used) or ping-pong/alternating communications when the same antenna is used. This can provide for increased bandwidth and node-to-node communication with less over the air overhead.

The above described embodiments are not intended to limit the scope of the present invention, as one skilled in the art can, in view of the present disclosure, expand such embodiments to correspond with the subject matter of the invention claimed below.

We claim:

1. A wireless network device, comprising:
a processor,
a power source,
a primary wireless radio, configured to support network communications protocols; and,
a secondary radio, configured to support a limited communications protocol and operable, in at least one mode, on less power than the primary radio.

2. The device of claim 1 wherein the communications protocols is 802.15.4

3. The device of claim 1 wherein the power source is a limited energy source, of a type which includes one or more of;
a battery or batteries,
solar power source, and;
mechanical generation power source.

4. The device of claim 1 wherein the lower power operating mode is receive mode.

5. The device of claim 1 wherein the primary and secondary radios share an antenna.

6. The device of claim 1 wherein the primary and secondary radios use independent antennae.

7. The device of claim 4 wherein the secondary radio's power consumption in low power receive mode is less than 1 mA an preferably less than 10 uA

8. A method of operating the wireless device of claim 1, comprising:
turning off the primary radio for selected time periods; and
during at least a portion of the selected time periods, turning on the secondary radio, such that the secondary radio either listens for a signal from a network, or queries the network on pre-determined intervals.

9. The method of claim 8, wherein when the secondary radio is on, upon communication with the network the primary radio is turned on.

10. The method of claim 8 wherein;
upon communication with the network, determines if the communication is meant for the device or meant for re-broadcast,
if the communication is intended for the device, cause the primary radio to wake and engage in full communication with a network; and,
if the communication is meant for re-broadcast, re-broadcast the signal.

11. The method of claim 8 wherein if the communication is meant for re-broadcast, the primary radio is not turned on.

12. The method of claim 9 wherein the primary radio, upon turn-on, communicates with a network, the device performs any required task, and the secondary radio is turned back off.

13. The method of claim 8 wherein the secondary radio is turned on and off with a predetermined duty cycle.

14. A method of operating the device of claim 1 in a battery power saving mode, comprising;
for at least a time period, operating with the primary radio turned off,
for at least part of the time period that the primary radio is off, operating with the secondary radio on,
upon receipt of a communication by the secondary radio, determine a first case that the communication is a request for full communication with a network and/or a second case that the communication is intended for re-broadcast; and,
in the first case, causing the primary radio to turn on and connect to the network and in the second case, re-broadcasting the communication.

15. A method of operating the device of claim 5 wherein communication is supported in a pin-pong mode such that the primary and secondary radios communicate in the same time period by interleaving access to the antenna.

16. A method of operating the device of claim 6 wherein the primary and secondary radios communicate simultaneously.
